(19) United States
(12) Patent Application Publication
(10) Pub. No.: US 2015/0292536 A1
(43) Pub. Date: Oct. 15, 2015

(54) FASTENING SYSTEM FOR ROUND OBJECTS

(71) Applicant: g2 Engineering, Saratoga, CA (US)

(72) Inventors: Ben Shelef, Saratoga, CA (US); Shmuel Erez, San Jose, CA (US)

(21) Appl. No.: 14/686,736

(22) Filed: Apr. 14, 2015

Related U.S. Application Data
(60) Provisional application No. 61/979,001, filed on Apr. 14, 2014.

(51) Int. Cl. F16B 2/20

(52) U.S. Cl. CPC F16B 2/20

(57) ABSTRACT

A system for fastening round objects, utilizing a bi-tapered groove for housing a clip ring, wherein the bi-tapered groove is formed by three separate elements: an open groove formed in the round object, a conical surface formed in a base plate, and a conical surface formed in a securing plate which is configured to be attached to the base plate. The clip ring is securely held inside the bi-tapered groove.

### CROSS-REFERENCE TO RELATED APPLICATION

The present disclosure relates to and claims priority from U.S. Provisional Application Ser. No. 61/979,001, filed on Apr. 14, 2014, the disclosure of which is incorporated herein by reference in its entirety.

### BACKGROUND

1. Field

The present disclosure relates to the field of mechanical fasteners.

2. Related Arts

In mechanical assemblies, it is common to need to fasten components to the outside of round objects such as shafts and piston rods, or to the inside of round objects such as hydraulic cylinders.

A common mechanism for such fastening is the clip ring (or snap ring) which is a ring with some elasticity (and thus a variable diameter) that is made to partially fit into a groove in the fastened body. The portion of the ring that protrudes outside of the groove is then used to fasten the object within the larger assembly.

Some examples where snap rings are used are actuating rod-ends, shaft retainers, hydraulic cylinders, and optical assemblies within tubes.

The accompanying drawings, which are incorporated in and constitute a part of this specification, exemplify the embodiments of the present invention and, together with the description, serve to explain and illustrate principles of the invention. The drawings are intended to illustrate major features of the exemplary embodiments in a diagrammatic manner. The drawings are not intended to depict every feature of actual embodiments nor relative dimensions of the depicted elements, and are not drawn to scale.

FIG. 1 depicts a simple circular clip ring [10], having rectangular cross-section, assembled around a shaft [11], such as used when pressing the shaft against the race of a ball bearing. The ring fits into a groove [12] that is formed into the shaft.

Because of manufacturing tolerances, gaps exist between the ring and the shaft, in both the radial direction [13] and the axial direction [14]. This is for the simple reason that if the ring is made slightly too thick, it won't fit in the slot. If it is made slightly too thin, there will be a gap and it will be able to rattle. A similar situation occurs with the diameter of the ring, creating the radial gap (Ignoring for the moment the issue of how to assemble the ring onto the shaft).

The axial load carrying capacity of retainer rings is typically determined by stress concentrations that occur at the root [19] and edge [18] of faces of the grooves that are perpendicular to the axial direction.

The radial gap is commonly eliminated by using a ring that can change its diameter by a small amount, as shown in FIG. 2, being (for example) slotted [21] or spiraled-and-flat-ground [22], or step-spiraled [23]. The adjustable rings are typically made so that their natural (relaxed) diameter is smaller than that of the groove in the shaft, so that upon assembly, the radial gap is naturally eliminated. The same diameter-adjustment mechanism also allows the ring to be slipped onto the groove on the shaft. A natural consequence of an adjustable ring is that after assembly its Outside Diameter (OD) is no longer known in advance, since it depends on the actual deviations in manufacturing of the ring and the groove. The uncertainty in the OD makes it difficult to then center the clip ring within a larger assembly. The axial gap, meanwhile, remains the same.

In the rest of this disclosure, the term “ring” is used to describe regular solid rings plus any of the variations shown in FIG. 2. Additionally, when spiraled or step-spiraled, the term “cross-section”, as applied to the ring, refers to the combined cross-section of the several revolutions that make up the spiral. In the same sense, all the rings are considered planar, even if their internal structure contains a spiral, since their external faces are shaped so they fit inside a planar groove.

In all figures, the components are shown in positions before they tighten into place, so the tolerance-induced gaps are still visible.

FIG. 3 depicts a simple round cross-section circular clip ring [30], placed in a round groove [31]. Similar to the case of the rectangular clip ring, if the ring cross-section diameter is larger than the groove cross-section diameter, it won't fit properly, resting only on the edges of the groove [32]. If it is too small, then it will fit loosely, resting only on its inner diameter line, and leaving crescent-shaped gaps on both its sides [33]. Therefore the round cross-section does not offer a significant improvement over the rectangular one.

FIG. 4 depicts a ring [40] with a cross-section that is down-tapered in the inwards direction, used to eliminate the aforementioned axial gap, using the same radial adjustment motion of the ring that eliminated the radial gap. The tapered edge of the cross-section thus forms a conical face [41]. The groove cut into the shaft [42] is formed with a matching conical face [43] (with the same forming angle) to that of the ring. Since all cones with the same forming angle are geometrically identical, it is guaranteed that when the ring adjusts in diameter, it forms a face-to-face contact with the groove, even if the depth and the width dimensions of the groove are not nominal. As before, once the ring adjusts to fit the groove, its OD is no longer known, since it depends on the actual dimensions of the groove in the shaft.

The forming angles of the conical faces used are typically small, to reduce outward radial force components that might try to open the ring when axial forces are acting on the conical face, since it is only held in place by friction. Still, the rings are typically intended to be used when compression forces are acting on the flat (non-conical) face [44].

A housing plate [45] is further attached to the clip ring, using a clamping plate [46], pulled towards it through screw holes [47]. Since the ring's OD is not known precisely, it is difficult to center it within the larger assembly, or fasten it to a mating feature in a positive manner in the radial direction, so typically it is fastened between parallel surfaces using friction. Additionally, the axial forces it can transmit are limited by deformations near the corners [48,49] where the ring meets the groove or the housing plates, and where stress concentrations naturally occur.

The geometry shown in FIG. 4 is often referred to as “Internally beveled”.

Rectangular, round, and beveled clip rings are prior art and can be purchased from a variety of industry sources such as Smaller Steel Ring Company, Rotor Clip Inc, or True-Arc.

### SUMMARY

The following summary is included in order to provide a basic understanding of some aspects and features of the invention. This summary is not an extensive overview of the invention and as such it is not intended to particularly identify key or critical elements of the invention or to delineate the scope of the invention. Its sole purpose is to present some concepts of the invention in a simplified form as a prelude to the more detailed description that is presented below.

The invention disclosed herein is a clip ring and groove system that improves on traditional clip rings, being self-centering in both the radial and axial dimensions, allowing higher sheer forces, and insensitivity to manufacturing tolerances.

Rather than using a rectangular or tapered cross-section for the ring groove, embodiments of this invention use a double-tapered, or “diamond shaped” cross-section. Further, one side of the groove is formed into the round object being fastened, and the other side of the groove is split between two components to which the round object is fastened.

Embodiment disclosed herein provide a system for fastening a round object, comprising: a ring enclosed in a bi-tapered groove system, said bi-tapered groove system comprising a first down-tapered groove formed into said round object, and a second down-tapered groove created by axial assembly of two mating bodies, wherein each of the mating body has an angled surface configured so that a separation between the two angled surfaces is reduced as the two mating bodies are tightened toward each other to thereby define the second down-tapered groove. A cross-section of said ring has inner tapered surface defined by reduction in thickness towards the rotational axis, and an outer tapered surface defined by reduction in thickness in a direction pointing away from the rotational axis. The first down-tapered groove is defined by two surfaces tilted at a non-zero angle with respect to a normal to the axis of rotation of the round object. A cross section of the ring comprises two tilted surfaces, each angled to be parallel to one of the two surfaces defining the first down-tapered groove. Each of the angled surface is being tilted at a non-zero angle with respect to a normal to the axis of rotation of the mating body and a cross section of the ring comprises two tilted surfaces, each angled to be parallel to one of two surfaces defining the second down-tapered groove. The round object may be a round rod or a sphere, and the two mating bodies comprise a housing plate and a clamping plate. The round object may comprise a rod having the first down-tapered groove formed over its circumference in a shape of a V-groove pointing radially towards the axis of the rod, such that each face of the V-groove forms a non-zero angle with a plane that is perpendicular to the axis of the rod. When the two mating bodies are coupled axially they define the second down-tapered groove as a mirror image of the V-groove. The ring may be configured to have its cross-section altered when inserted between the first and second down-tapered grooves.

According to disclosed aspects, a fastening system for fastening to a round object is provided, said round object having an axis of rotation and a corresponding axial direction, said fastening system comprising a groove formed in the round object, said groove being planar and rotationally symmetric about said axis of rotation, and having at least one conical face so that cross-section of the groove is down-tapered radially, and said system further comprising a planar ring, said ring having inner conical faces and outer conical faces, wherein one of the inner and outer conical faces match said conical face of said groove. The groove may be formed over an external or internal circumference of the round object. The fastening system may further comprise a base plate and a securing plate configured to, when mated axially, form a second groove having at least one conical surface, so as to house part of the planar ring. The planar ring may be made of malleable material and having round cross-section, and wherein the base plate and the securing plate are configured to tangentially compress the planar ring.

According to further aspects, a method for fastening a round object is provided, comprising: forming a groove around a surface of the round object, the groove being planar and rotationally symmetric about as axis of rotation, and having at least one conical face so that cross-section of the groove is down-tapered radially; inserting a clip ring in the groove; forming a conical surface on a base plate and placing the base plate on one side of the clip ring such that the conical surface tangentially touches the clip ring; forming a complementary conical surface on a securing plate and placing the securing plate on another side of the clip ring, facing the base plate, such that the complementary conical surface tangentially touches the clip ring; and attaching the securing plate to the base plate. The method may further comprise compressing the ring during the step of attaching the securing plate to the base plate, so as to modify a cross section of the clip ring. The method may further comprise forming four conical surfaces around the circumference of the clip ring. The groove may be formed on internal or external surface of the round object.

Other features and advantages of the disclosed invention will become apparent from the detailed description provided below, relating to exemplary embodiments.

### BRIEF DESCRIPTION OF THE DRAWINGS

The accompanying drawings, which are incorporated in and constitute a part of this specification, exemplify the embodiments of the present invention and, together with the description, serve to explain and illustrate principles of the invention. The drawings are intended to illustrate major features of the exemplary embodiments in a diagrammatic manner. The drawings are not intended to depict every feature of actual embodiments nor relative dimensions of the depicted elements, and are not drawn to scale.

FIG. 1 shows a simple rectangular circular clip ring. (Prior Art).

FIG. 2 shows methods for creating variable-diameter rings. (Prior Art).

FIG. 3 shows a simple round cross-section circular clip ring. (Prior Art).

FIG. 4 shows an internally beveled circular clip ring. (Prior Art).

FIG. 5 shows a bi-tapered clip ring and groove system according to one embodiment.

FIG. 6 shows a bi-tapered groove system and round ring according to another embodiment.

FIG. 7 shows a comparison between cross sections of several embodiments.

FIG. 8 shows a clip ring around a sphere according to another embodiment.

FIG. 9 shows a bi-tapered rhombus-shaped groove system and ring according to another embodiment.

FIG. 10 shows bi-tapered non-symmetrical groove system and ring according to another embodiment.

FIG. 11 shows an externally beveled clip ring. (Prior Art).

FIG. 12 shows a clip ring and groove system in an internal fitting according to one embodiment.

FIG. 13 depicts the notations for Forming Angle and Cone Angle according to one embodiment.

### DETAILED DESCRIPTION

1. Nomenclature

A ring, or a cylinder, naturally establish axial, radial, and circumferential directions, and these terms are used as generally accepted.

The term “down-tapered” as used in this disclosure refers to a reduction in thickness of the cross section of mating features, where the thickness is measured in the axial direction, and the reduction occurs along the radial direction, as one moves away from the ring (either inwards or outwards). Thus in cross-section, a down-taper is the notional opposite of the feature commonly known as a “dove tail”.

A “Bi-tapered” cross section is one that is down-tapered both inwards and outwards (radially), so that it is thickest just between the parts being mated.

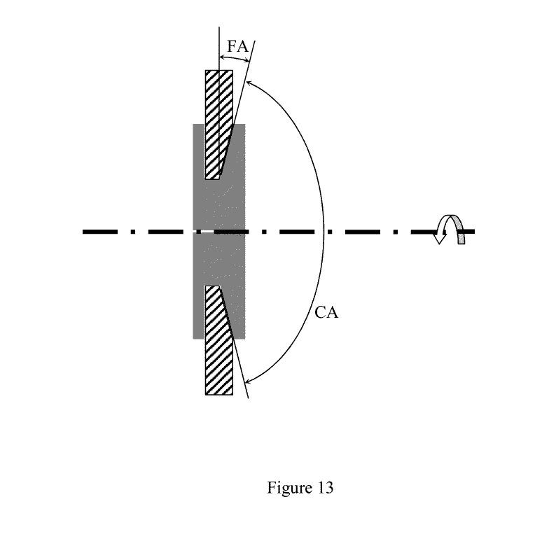

The term “forming angle” as used in this disclosure refers to the amount of taper given the ring's face (in cross-section), so that a rectangular ring has a forming angle of 0, and a slight taper has a small forming angle. Considering the internal full angle of the cone described by the formed face, it naturally equals to 180 minus twice the forming angle. The forming angle (“FA”) and cone angle (“CA”) are illustrated in FIG. 13.

2. Detailed Description of Embodiments

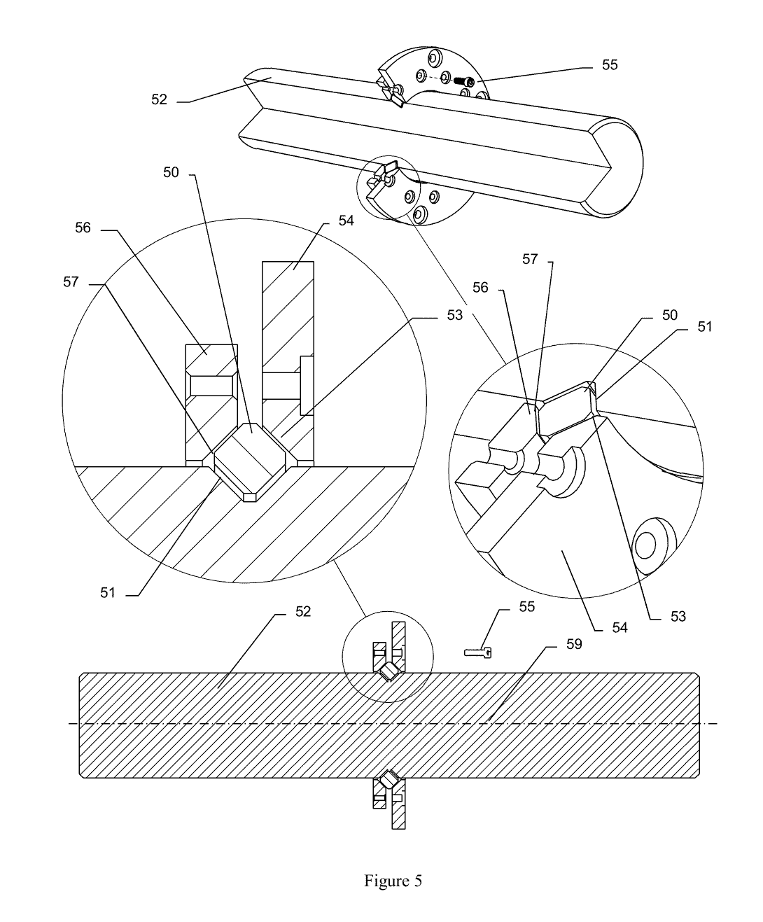

FIG. 5 shows an embodiment of the invention, where the cross-sections of both the ring [50] and groove system (whose components are enumerated below) are diamond shaped. The embodiment of FIG. 5 provides a system for fastening a round object, such as a rod or shaft [52] of FIG. 5, which comprises a ring [50] enclosed in a bi-tapered groove system. The bi-tapered groove system comprises a first down-tapered groove [51] formed into the round object, and a second down-tapered groove created by the axial assembly of two mating bodies having angled surfaces facing each other, i.e., angled surfaces [53] and [57] of housing plate [54] and clamping plate [56], wherein the two mating bodies are configured so that the second down-tapered groove is pinched as the two mating bodies are tightened toward each other.

As shown in FIG. 5, the angled surfaces [53] and [57] of housing plate [54] and clamping plate [56] are conical surfaces, as they are surfaces of revolution. Similarly, the angled surfaces of the ring [50] also define cone sections and are, therefore referred to as conical surfaces. The same holds for the surfaces forming the down-tapered groove [51].

The cross-section of the ring [50] is a square rhombus (“Diamond”) with truncated corners, such as can be produced by passing a round wire through a square die, so is easily manufacturable. The cross-section of the ring [50] has inner tapered surface defined by reduction in thickness towards the rotational axis [59], and an outer tapered surface defined by reduction in thickness in a direction pointing away from the rotational axis [59].

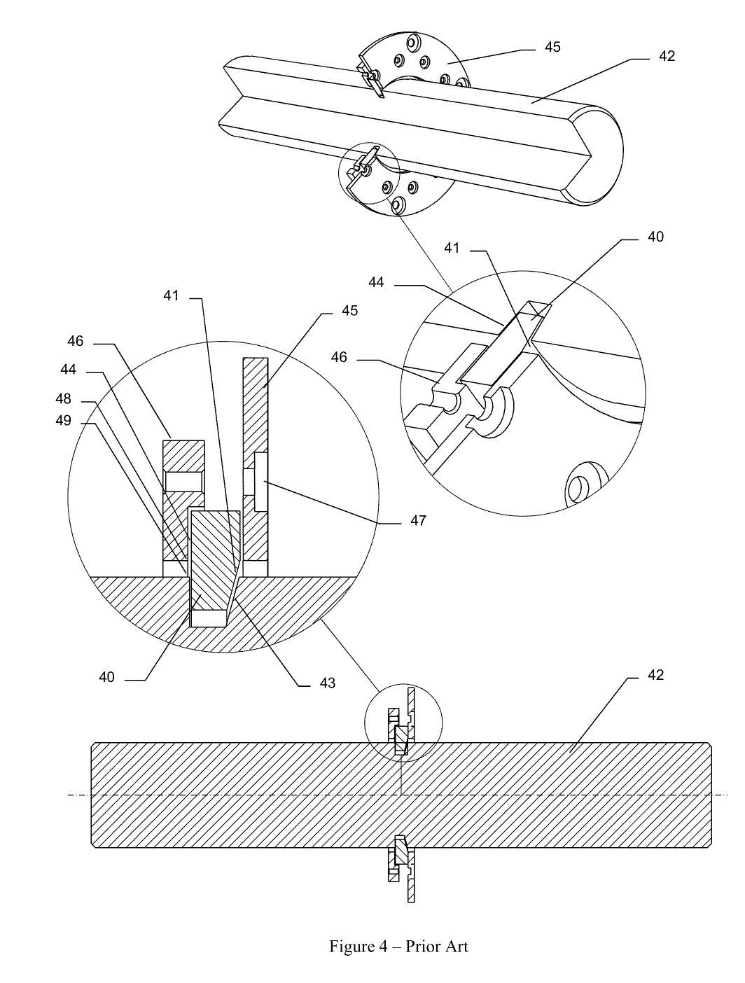

The inner portion of the groove [51] is located on the shaft [52] and being down-tapered, behaves just like in FIG. 4, accepting the clip ring which snaps into place and matches its diameter even if there is a manufacturing tolerance on the depth of the groove. Because of the symmetrical shape of the groove, the ring self-centers in it. Due to the manufacturing tolerances in the groove, the outer diameter of the ring, as assembled, is not precisely known.

The outer portion if the groove is formed by bringing together a housing plate [54] and a clamping plate [56], each of the plates having a tapered face [53] and [57], respectively, that together form an external down-tapered groove, and tightening them in the axial direction toward each other. As the two plates are tightened toward each other, the external down-tapered groove effectively shrinks around the ring [50], eliminating any tolerances, and simultaneously self-centers the assembly around the ring. Since all cones with the same forming angle are geometrically identical, the faces fit without deforming, even if the diameters of the grooves have manufacturing tolerances. The internal down-taper of the groove introduces a reduction in thickness in the axial direction towards the central axis. The external down-taper introduces a reduction in thickness in the axial direction away from the central axis.

The second (external) down-taper groove [53] of the ring [50] is secured within a combination of a housing plate [54] and a clamping plate [56]. The housing plate [54] includes a tapering cut [55], presenting a mating surface to down-taper [53] of the ring [50]. Stated another way, a taper cut [55] on the housing is configured to complement a taper but in the retained object, such as shaft [52]. When the taper cut [55] of the housing plate [54] is aligned with the taper cut in the shaft [52], a triangle cut is presented for a ring having an inner down-tapper and outer down-taper, such that the inner down-taper of the ring fits inside the taper cut in the shaft [52] and the outer down-taper of the ring fits within the taper cut in the housing plate [54]. As described above, due to manufacturing tolerances, the OD of the clip ring [50] will vary in order to guarantee face-to-face contact between the ring [50] and the shaft [52]. However, with the conical face of the housing plate [54], it becomes possible to center the ring [50] within the housing plate [54] irrespective of its actual OD—the clamping plate [56] will simply end up in a different axial location relative to the housing plate [54].

Additionally, the presence of the cones on the housing plate [54] and clamping plates [56] positively prevents the clip ring [50] from opening due to axial forces even if the cone forming angle is high, allowing the use of larger forming angles than was possible in the prior art depicted in FIG. 4.

Additionally, since the ring and groove do not have faces that are at 90 degrees to axial forces, the bi-tapered groove reduces stress concentrations, allowing higher axial forces to be transferred between the shaft and the housing/clamping plates, through the conical contact faces.

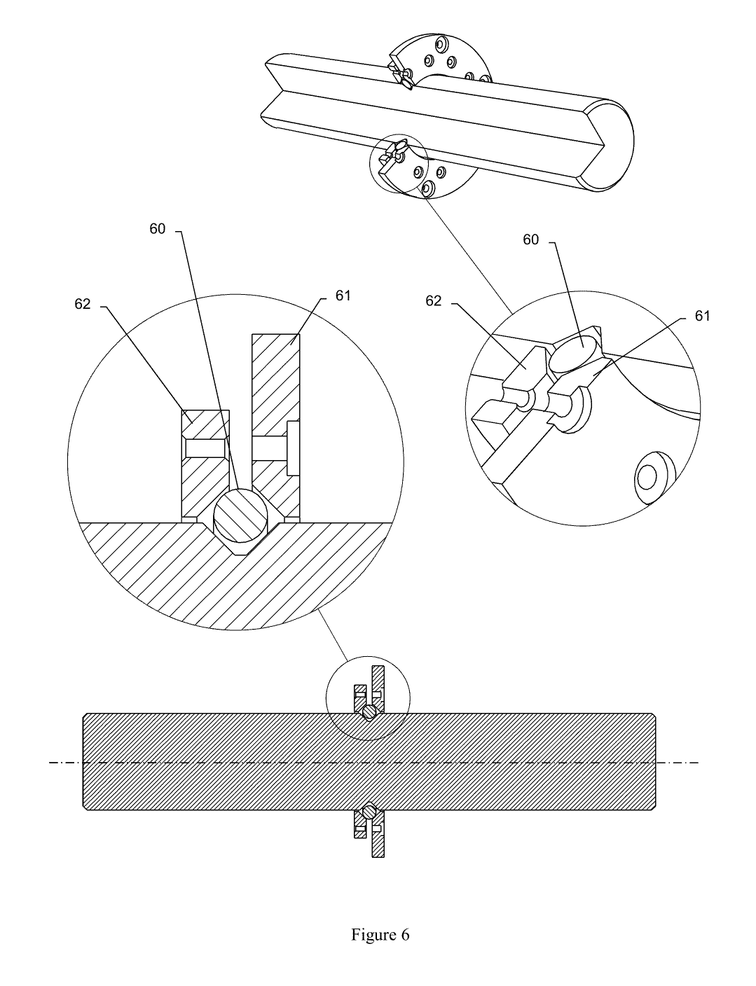

FIG. 6 depicts an embodiment of the invention where the ring [60] has a round cross section, but is still enclosed in the same groove system depicted in FIG. 5.

In this embodiment, as the housing plate [61] is tightened to the clamping plate [62], the ring is deformed to conform to the tapered faces making up the bi-tapered groove system.

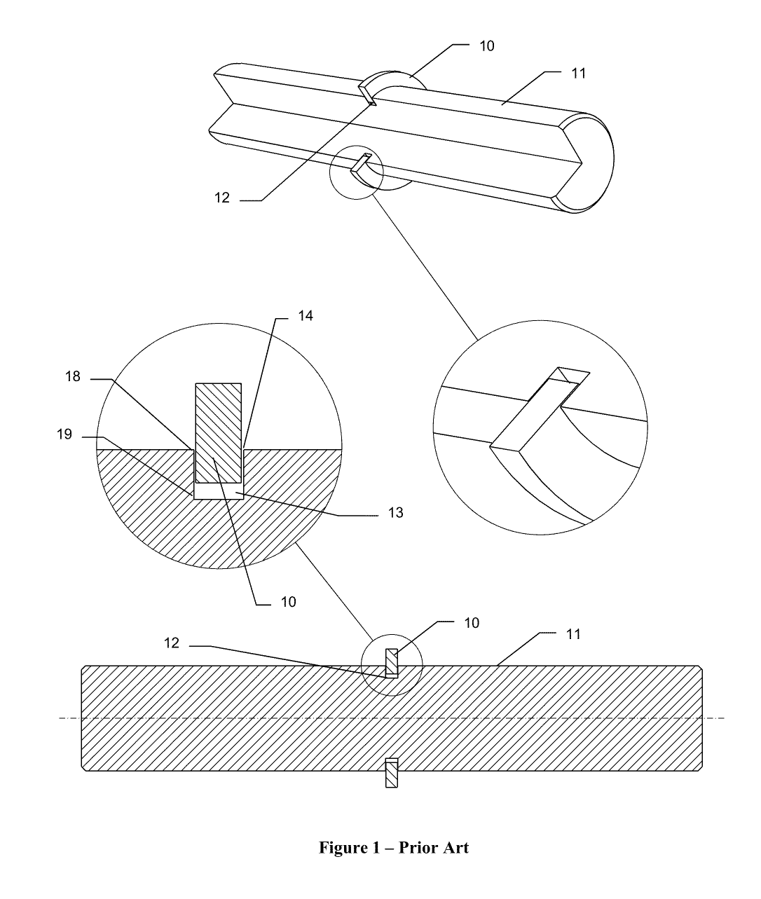

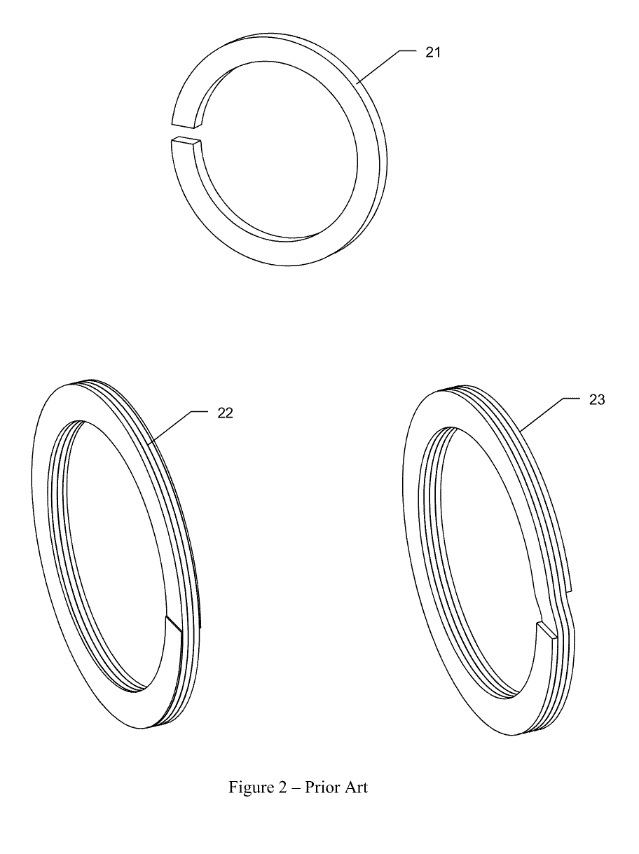

The deformation occurs in the direction perpendicular to the faces and thus creates conical faces on the ring. This is important in order to retain the tolerance insensitivity that characterized the embodiment depicted in FIG. 5. If contact between the ring and groove system occurs along the axial or radial directions, then the closing of the ring and the tightening of the two plates will not be able to eliminate manufacturing tolerances, and the design will suffer from the same shortcomings as did the prior art depicted in FIGS. 1-4.

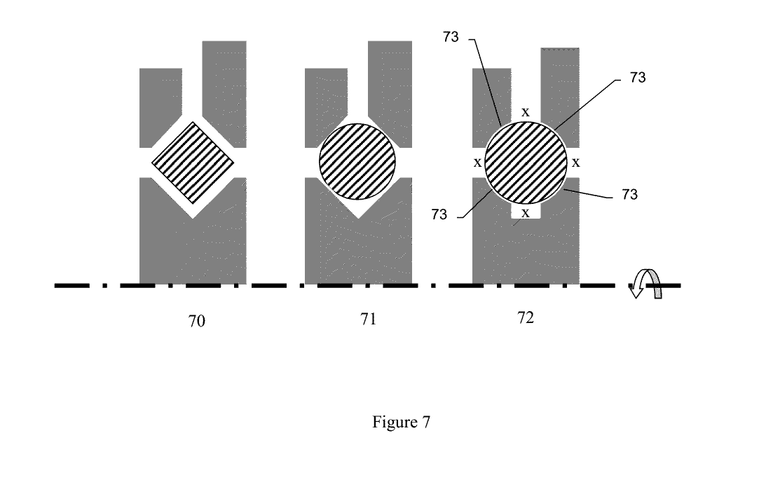

FIG. 7 shows several embodiment cross sections that achieve equivalent results. Cross-section 70 is the same as diamond ring and groove system detailed in FIG. 5. Cross-section 71 is the same as diamond ring and groove system detailed in FIG. 6. Cross-section 72 is a similar variation, but using a near-round cross-section groove system. This embodiment approximates the embodiment depicted in FIG. 6, as long as the arcs of contact [73] do not reach the axial and radial peak locations (denoted by “x”).

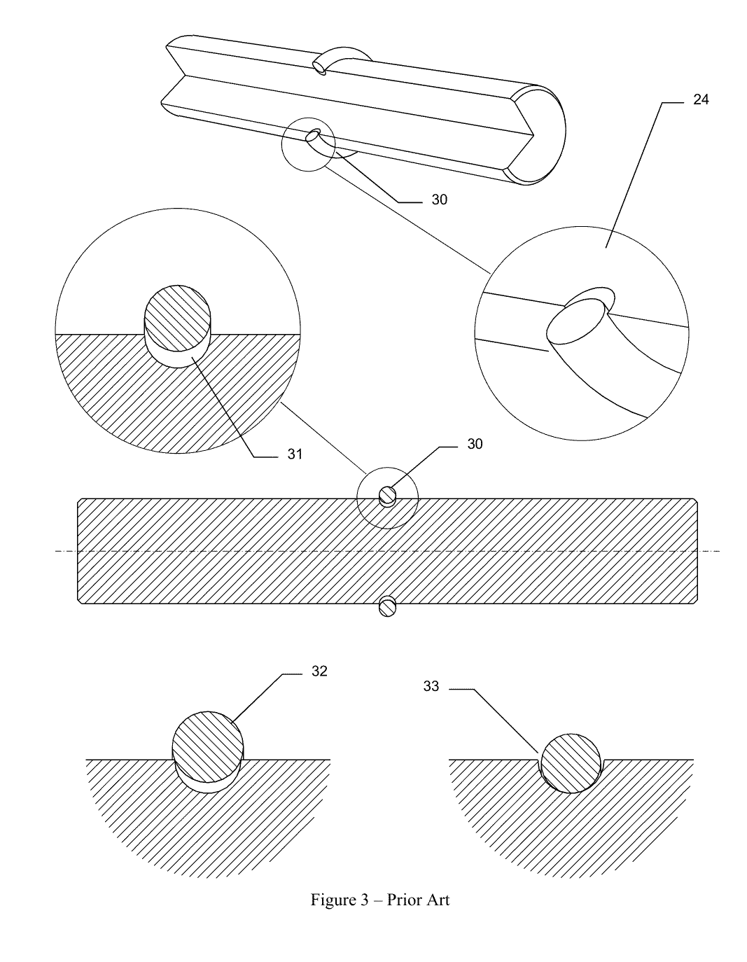

If the arcs of contact are too long, the embodiment will suffer from the same problems as the prior art depicted in FIG. 3, since the groove system will not be able to compensate for radial or axial tolerances. Thus the groove system must not contact the ring at the spots marked as “x”.

In this embodiment there is a tradeoff for how much arc length is used for contact. Longer arcs can carry higher loads, but smaller reliefs will make the tightening less effective. Reliefs of 30 to 60 degrees (leaving 60 to 30 degrees of arc engagement) are a good sweet spot in this case.

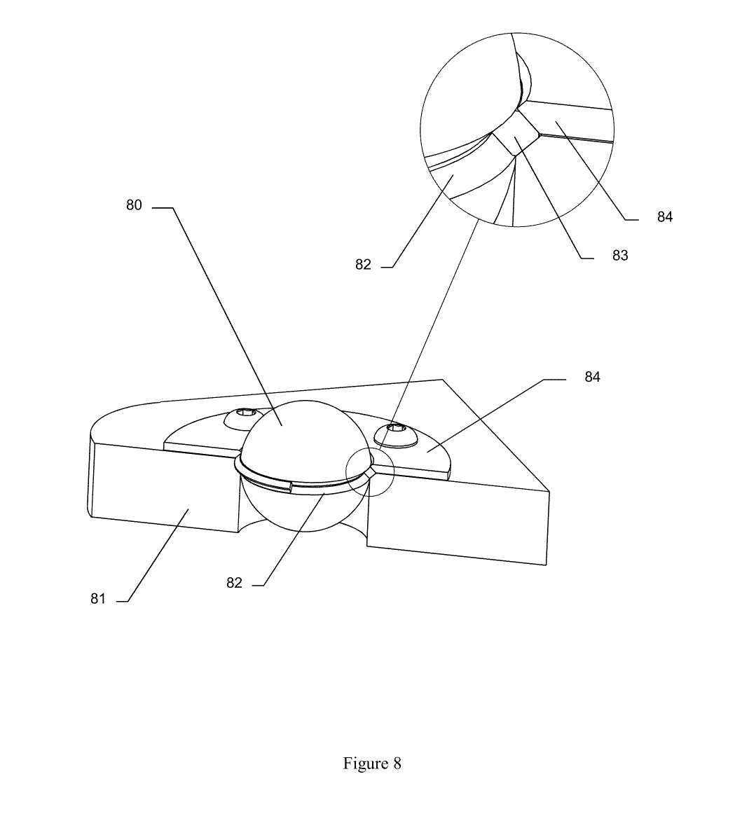

FIG. 8 depicts an embodiment of the invention where a square rhombus ring [83] is used to fasten a sphere [80] (rather than a shaft) to a baseplate [81]. The Sphere features a matching groove [82] onto which the ring is snapped. Then, a clamp plate [84] is bolted onto the baseplate in order constrain the ring in both radial and axial directions.

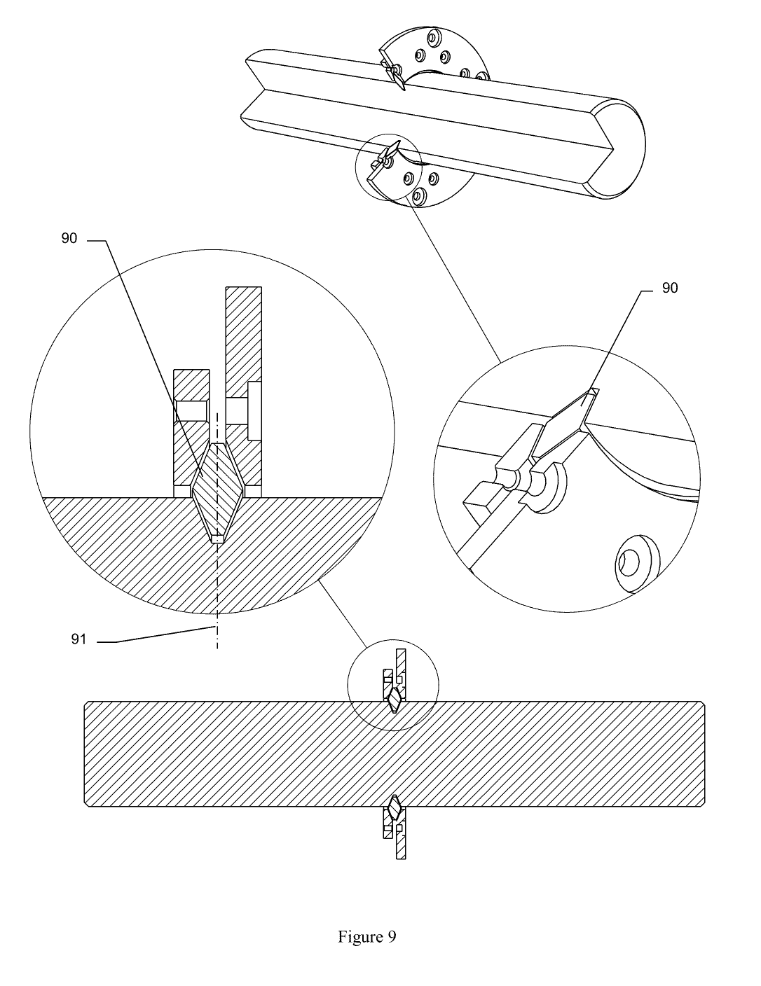

FIG. 9 depicts an embodiment of the invention where the ring [90] and groove system have a cross section in the shape of a rhombus. Since the rhombus is symmetrical about a radial plane [91], this embodiment retains the self-centering ability.

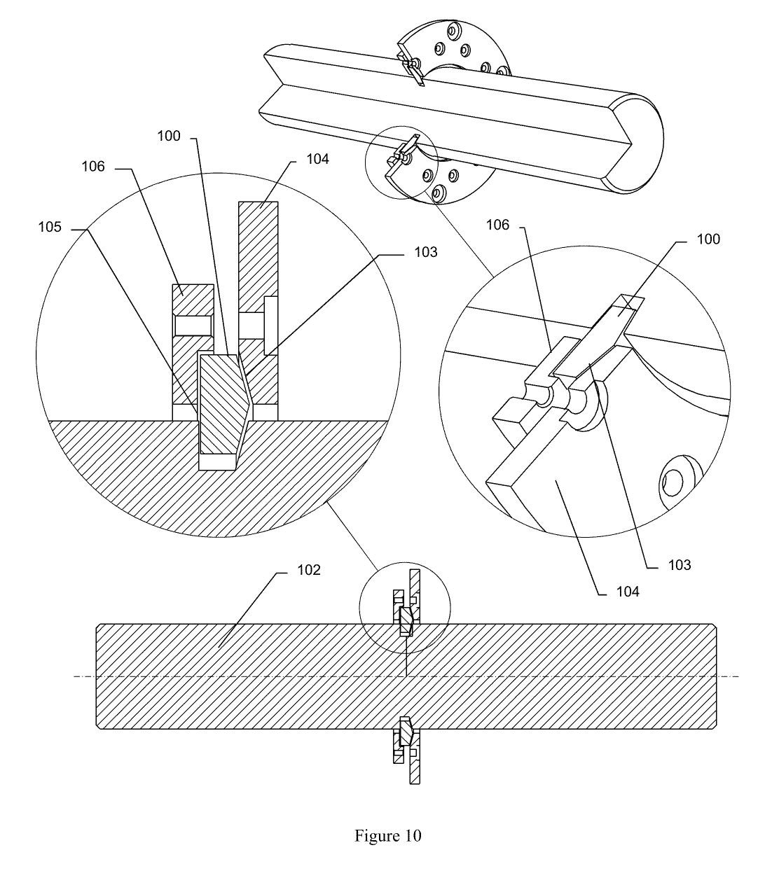

FIG. 10 depicts an embodiment of the invention where the ring [100] and groove system are not symmetrical, but are still bi-tapered. As such, the axial tightening of the housing plate [104] to the clamping plate [106] still guarantees that all manufacturing tolerances are eliminated, but the assembly no longer self-centers. Additionally, because the ring [100] and groove system have a face that is perpendicular to the axial direction [105], this embodiment will see increased stresses around the around the edges of this face.

In all of the above embodiments, the clip ring is designed to radially contract onto the external face of an inner round object, and then clamped by the housing assembly from the outside. This is referred to in this disclosure as an external clip ring. However it is also possible to design a clip ring intended to radially expand onto the internal face of a cylindrical housing. In this disclosure, such a ring is referred to as an internal clip ring. The general practice of using internal clip rings to fasten to internal diameters is normal practice and existing art. In such a configuration the roles of the Inner and Outer diameters are exactly reversed.

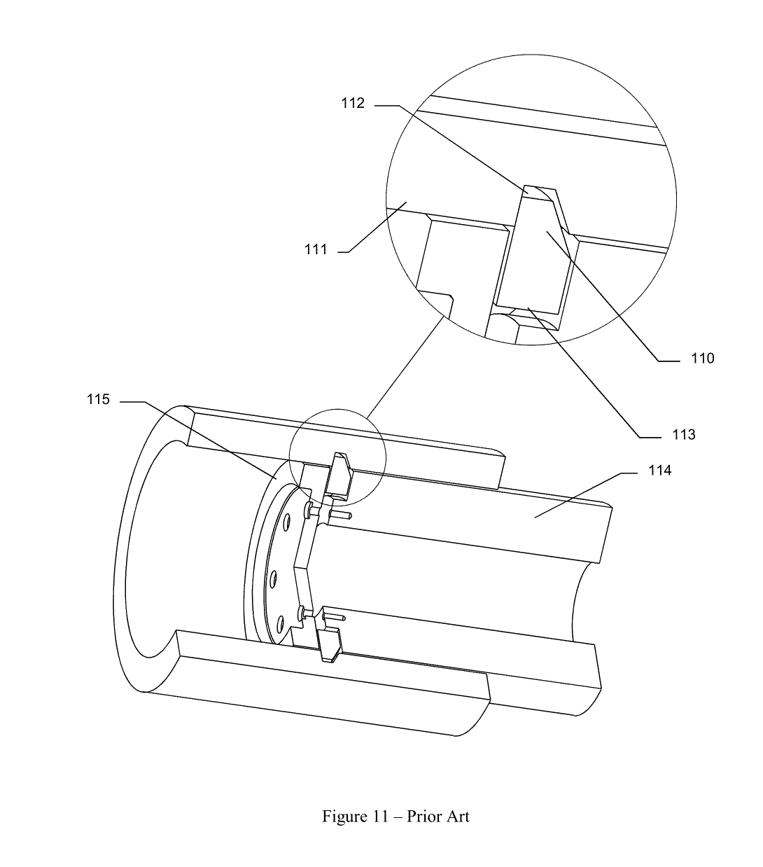

FIG. 11 depicts an existing art internal clip ring [110], so instead of fastening to the outside of a shaft (for example) it is fastened to the inside of a cylinder [111]. The ring is down-tapered outwards instead of inwards, and is made so its relaxed diameter is larger than the groove

in which it is to reside. Thus when assembled, it naturally presses outwards into the groove. In this configuration, it is the inner diameter of the ring [113] that remains exposed, and its dimension is not known with certainty, since the amount of expansion depends on the deviations in the dimensions of the groove and ring. In this geometry it is the inner shaft [114] (rather than a housing plate) that uses a clamping plate [115] to grab the clip ring [110] using friction.

The geometry shown in FIG. 11 is often referred to as “externally beveled”.

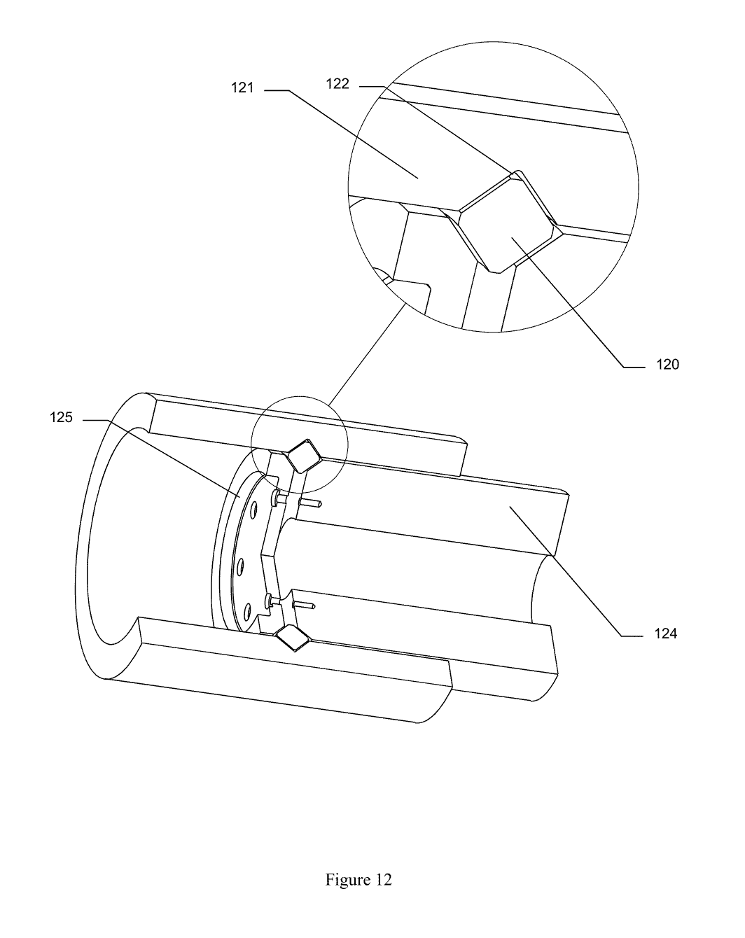

FIG. 12 depicts an embodiment of the invention using a square rhombus (Diamond) cross-section, but used as an internal clip ring. As in prior art, the clip ring [120] is designed to naturally expand into the groove [122] in the outer housing [121] to eliminate deviations between them in both the radial and axial directions. However, the ring's internal diameter is now also down-tapered, and so can be fastened between the inner shaft [124] (equivalent to the housing plate in FIG. 5) and clamping plate [125] so that when the clamping plate is tightened towards the shaft in the axial direction, it eliminates the manufacturing deviations in both axial and radial directions, and self-centers the parts.

Other embodiments of the invention include internal clip rings utilizing the ring and groove geometries described for external rings, depicted in FIG. 5-FIG. 10.

The above embodiments illustrate the underlying principle of the invention. A clip ring is located between two down-tapered grooves. The first groove is formed into a round body, and the second is formed by two bodies that are tightened towards each other in the axial direction. The first groove formed into the body is axially aligned with the second groove formed by the two matting bodies.

The ring is able to close on the first groove, forming a positive contact with its faces (which are neither axial nor radial). The tightening of the two bodies in the axial direction causes the second groove that is formed between them to tighten around the ring, so that all manufacturing deviations in diameter and thickness are eliminated.

Due to manufacturing tolerances, the clips ring will be deformed by the more massive solid bodies containing the grooves as tightening progresses. In fact in some embodiments, this deformation can be relied upon in order to simplify manufacturing.

The utility of the invention is therefore as follows:

First, it enables a positive, rattle-free assembly while allowing deviations to exist in the feature dimensions (diameter, width) of the shaft groove, the ring, and the mounting assembly. In the state of the art, rattle-free assembly can be achieved between the ring and the shaft, but in the radial direction, friction must be used to clamp down on the clip ring.

Second, it enables a radially centered assembly, again while allowing deviations to exist in the feature dimensions (diameter, width) of the shaft groove, the ring, and the mounting assembly—which is not possible in the state of the art.

Third, it allow high axial forces to be applied, since it eliminated points of stress concentration that are a natural result of small or non-existent forming angles, as is common in the state of the art.

In the embodiments disclosed, the taper may be formed on both sides of the ring, i.e., the inner taper is formed on both sides/surfaces of the ring and the outer taper is formed on both sides/surfaces of the ring. Consequently, in these embodiments the cross-section of the ring assumes a diamond shape, either during the manufacture or while assembling by having the ring made of a malleable material and deforming it during tightening of the clamping plate to the housing plate. The symmetry in the cross-section about the radial line adds the property that the ring self-centers in the groove (along the axial direction), and the housing plate assembly self-centers around the ring.

In the symmetrical-cut embodiments, the housing plate includes a tapering cut presenting a mating surface to the outer down-taper on one side the ring. The clamping plate also has a tapering cut presenting a mating surface to the outer down-taper on the other, opposing, side the ring. The shaft has a double-taper cut, presenting two mating surfaces to the inner down-tapers on both sides of the ring. The tapering cuts in the housing plate, the clamping plate, and the shaft are all made at a non-zero angle to a plane that is perpendicular to the axis of the shaft.

The taper cut on the housing and the taper cut on the clamping plate are configured to complement the double taper cut in the shaft, and may form a mirror-image of the double-taper cut in the shaft. When the taper cut of the housing plate and the taper cut on the clamping plate are aligned with the double taper cut in the shaft, they together define a diamond shape space presented for a ring having an inner down-tapper and outer down-taper on both of its sides, such that the inner down-taper on both sides of the ring fit inside the double-taper cut in the shaft, and the outer down-taper on both sides of the ring fit within the double-taper space defined by the taper cuts in the housing plate and the clamping plate.

Having tapered surfaces on both sides of the fastening system add utility and benefits not previously recognized. As noted above, it provides reduced forces and self-centering. In essence, the groove system provides particular benefits and, according to disclosed embodiments is made out of three parts: half of the groove is on the fastened body, a quarter is on the housing plate and a quarter is on the fastening plate. The action of tightening the clamping plate to the housing plate generates a self-centering action.

Among the embodiments disclosed, a fastening system for fastening to a round object is provided, said round object having an axis of rotation and a corresponding axial direction, said fastening system comprising an internal groove formed in interior surface of the round object, said groove being planar and rotationally symmetric about said axis of rotation, and having at least one conical face so that its cross-section is down-tapered in the outward direction away from the axis of rotation, and said system further comprising a planar ring, said ring having outer conical faces that match said conical faces of said groove, and said ring further having at least one conical face so that its cross-section is down-tapered in the inward direction towards the axis of rotation.

Also, a fastening system for fastening to a round object is disclosed, said round object having an axis of rotation and a corresponding axial direction, said fastening system comprising a planar V-groove in the round object, and said system further comprising a planar diamond cross-section ring, two faces of said diamond cross-section ring matching said V-groove.

Additionally, a fastening system for fastening to a round object is provided, said round object being having an axis of rotation and a corresponding axial direction, said fastening system comprising a planar groove in the round object, and said system further comprising a planar circular cross-section ring, said groove contacting said ring along two distinct circular regions separated from each other by the mid-plane of the ring.

It should be understood that processes and techniques described herein are not inherently related to any particular apparatus and may be implemented by any suitable combination of components. Further, various types of general purpose devices may be used in accordance with the teachings described herein. It may also prove advantageous to construct specialized apparatus to perform the method steps described herein. The present invention has been described in relation to particular examples, which are intended in all respects to be illustrative rather than restrictive. Those skilled in the art will appreciate that many different combinations of functional elements will be suitable for practicing the present invention. Moreover, other implementations of the invention will be apparent to those skilled in the art from consideration of the specification and practice of the invention disclosed herein. Various aspects and/or components of the described embodiments may be used singly or in any combination in the relevant arts. It is intended that the specification and examples be considered as exemplary only, with a true scope and spirit of the invention being indicated by the following claims.

What is claimed is:

1. A system for fastening a round object, comprising: a ring enclosed in a bi-tapered groove system, said bi-tapered groove system comprising a first down-tapered groove formed into said round object, and a second down-tapered groove created by axial assembly of two mating bodies, wherein each of the mating body has an angled surface configured so that a separation between the two angled surfaces is reduced as the two mating bodies are tightened toward each other to thereby define the second down-tapered groove.

2. The system of claim 1, wherein a cross-section of said ring has inner tapered surface defined by reduction in thickness towards the rotational axis, and an outer tapered surface defined by reduction in thickness in a direction pointing away from the rotational axis.

3. The system of claim 1, wherein the first down-tapered groove is defined by two surfaces tilted at a non-zero angle with respect to a normal to the axis of rotation of the round object.

4. The system of claim 3, wherein a cross section of the ring comprises two tilted surfaces, each angled to be parallel to one of the two surfaces defining the first down-tapered groove.

5. The system of claim 1, wherein each of the angled surface is being tilted at a non-zero angle with respect to a normal to the axis of rotation of the mating body.

6. The system of claim 5, wherein a cross section of the ring comprises two tilted surfaces, each angled to be parallel to one of two surfaces defining the second down-tapered groove.

7. The system of claim 1, wherein the round object comprises a round rod, and the two mating bodies comprise a housing plate and a clamping plate.

8. The system of claim 1, wherein the round object comprises a sphere, and the two mating bodies comprise a base plate and a clamping plate.

9. The system of claim 1, wherein the round object comprises a rod having the first down-tapered groove formed over its circumference in a shape of a V-groove pointing radially towards the axis of the rod, such that each face of the V-groove forms a non-zero angle with a plane that is perpendicular to the axis of the rod.

10. The system of claim 9, wherein when the two mating bodies are coupled axially they define the second down-tapered groove as a mirror image of the V-groove.

11. The system of claim 10, wherein the ring is configured to be inserted between the first and second down-tapered grooves.

12. The system of claim 11, wherein the ring is configured to have its cross-section altered when inserted between the first and second down-tapered grooves.

13. A fastening system for fastening to a round object, said round object having an axis of rotation and a corresponding axial direction, said fastening system comprising a groove formed in the round object, said groove being planar and rotationally symmetric about said axis of rotation, and having at least one conical face so that cross-section of the groove is down-tapered radially, and said system further comprising a planar ring, said ring having inner conical faces and outer conical faces, wherein one of the inner and outer conical faces match said conical face of said groove.

14. The fastening system of claim 13, wherein the groove is formed over an external circumference of the round object.

15. The fastening system of claim 13, wherein the groove is formed over an internal circumference of the round object.

16. The fastening system of claim 13, further comprising a base plate and a securing plate configured to, when mated axially, form a second groove having at least one conical surface, so as to house part of the planar ring.

17. The fastening system of claim 16, wherein the planar ring is made of malleable material and having round cross-section, and wherein the base plate and the securing plate are configured to tangentially compress the planar ring.

18. A method for fastening a round object, comprising:
forming a groove around a surface of the round object, the groove being planar and rotationally symmetric about as axis of rotation, and having at least one conical face so that cross-section of the groove is down-tapered radially;
inserting a clip ring in the groove;
forming a conical surface on a base plate and placing the base plate on one side of the clip ring such that the conical surface tangentially touches the clip ring;
forming a complementary conical surface on a securing plate and placing the securing plate on another side of the clip ring, facing the base plate, such that the complementary conical surface tangentially touches the clip ring;
attaching the securing plate to the base plate.

19. The method of claim 18, further comprising compressing the ring during the step of attaching the securing plate to the base plate, so as to modify a cross section of the clip ring.

20. The method of claim 18, further comprising forming four conical surfaces around the circumference of the clip ring.

21. The method of claim 18, wherein the groove is formed on internal surface of the round object.
